(19) United States
(12) Patent Application Publication
(10) Pub. No.: US 2021/0368480 A1
(43) Pub. Date: Nov. 25, 2021

(54) COMMUNICATION SYSTEM AND TERMINAL DEVICE

(71) Applicant: FUJITSU LIMITED, Kawasaki-shi (JP)

(72) Inventors: Hongyang CHEN, Kawasaki (JP); Huiting Cheng, Yokohama (JP); Jianming Wu, Kawasaki (JP)

(73) Assignee: FUJITSU LIMITED, Kawasaki-shi (JP)

(21) Appl. No.: 17/393,741

(22) Filed: Aug. 4, 2021

Related U.S. Application Data
(63) Continuation of application No. PCT/JP2019/005436, filed on Feb. 14, 2019.

(51) Int. Cl. H04W 72/02; H04W 28/26; H04W 72/12; H04W 72/00

(52) U.S. Cl. CPC H04W 72/02; H04W 72/005; H04W 72/1263; H04W 28/26

(57) ABSTRACT

A communication system includes a first terminal and a second terminal. The second terminal is configured to reserve a resource within a resource group that may be allocated for a data transmission, and broadcast a notification signal including reservation information on the resource. The first terminal device is further configured to receive the notification signal, select a resource to be used from the reserved resource based on the reservation information included in the notification signal, and transmit a feedback signal including radio layer information by using the selected resource to the second terminal device. The second terminal device is further configured to receive the feedback signal including the radio layer information from the first terminal device, allocate a resource for data transmission to the first terminal device, and releases, when the feedback signal is received, reservation of the resource used for the feedback signal.

### CROSS-REFERENCE TO RELATED APPLICATION

This application is a continuation application of International Application PCT/JP2019/005436 filed on Feb. 14, 2019 and designated the U.S., the entire contents of which are incorporated herein by reference.

### FIELD

The embodiments discussed herein are related to a communication system and a terminal device.

### BACKGROUND

In the current networks, for example, the traffic of mobile terminals such as smartphones and feature phones accounts for a majority of the communication networks. Furthermore, the traffic used by the mobile terminals tend to expand.

Meanwhile, with the development of Internet of things (IoT) services (e.g., monitoring systems such as a traffic system, a smart meter, and a device), it has been demanded to cope with services including various requirement. Consequently, the communication standards of the 5th generation mobile communication (5G or New Radio (NR)), it has been demanded that, in addition standard techniques to the fourth generation mobile communication (4G), techniques, which achieve a higher data rate, a larger capacity, and lower latency. Note that technical studies of the 5th generation communication standards are being conducted by 3GPP working groups (for example, TSG-RAN WG1, TSG-RAN WG2, and others).

In order to support various kinds of services as described above, 5G is assumed to support many use cases categorized, e.g., enhanced Mobile Broadband (eMBB), massive Machine Type Communications (MTC), and Ultra-Reliable and Low Latency Communication (URLLC). Also, the 3GPP working groups are discussing vehicle-to-everything (V2X) communication. Furthermore, the 3GPP working groups are also discussing device-to-device (D2D) communication. D2D communication is also called sidelink communication. Also, as an example of D2D communication, V2X is being studied. V2X communication is communication using, for example, sidelink channels, and examples of V2X communication include vehicle-to-Vehicle (V2V) communication, vehicle-to-pedestrian (V2P) communication, and vehicle-to-infrastructure (V2I) communication. V2V communication is communication between automobiles; V2P communication, between automobiles and pedestrians; and V2I communication, between automobiles and road infrastructures such as traffic signs. Specifications on V2X are described, for example, in 3GPP TS 22.186 V15.2.0 (2017-09). In V2X of 4G, two data transmissions are performed for one data piece without performing feedback to data transmission.

The method of allocating resources of V2X of 4G include, for example, a method of control centrally performed by a mobile communication system and a method of control autonomously performed by each terminal device performing V2X. The method of control centrally performed by a mobile communication system is applicable to a case where terminal devices performing V2X are within the coverage of a base station of the mobile communication system. This control method is also called mode 1. On the other hand, the method of control autonomously performed by each terminal device is also applicable to a case where terminal devices are out of coverage in a base station. This control method is also called mode 2. In mode 2, communication for resource allocation is not performed between the terminal devices and the base station.

Furthermore, relating to mode 2, a method has been studied in which a plurality of terminal devices is grouped, one terminal device of the plurality of terminal devices is handled as a head station (or scheduling station (scheduling UE)) and the other terminal devices excluding the head station are handled as member stations, and the head station autonomously allocates radio resources to the plurality of member stations.

Related techniques are disclosed in for example 3GPP TS 22.186 V15.2.0 (2017-09), 3GPP TS 36.211 V15.1.0 (2018-03), NPL 3: 3GPP TS 36.212 V15.1.0 (2018-03), 3GPP TS 36.213 V15.1.0 (2018-03), 3GPP TS 36.300 V15.1.0 (2018-03), 3GPP TS 36.321 V15.1.0 (2018-03), 3GPP TS 36.322 V15.0.1 (2018-04), 3GPP TS 36.323V14.5.0 (2017-12), 3GPP TS 36.331 V15.1.0 (2018-03), 3GPP TS 36.413 V15.1.0 (2018-03),3GPP TS 36.423 V15.1.0 (2018-03), 3GPP TS 36.425 V14.1.0 (2018-03), 3GPP TS 37.340 V15.1.0 (2018-03), 3GPP TS 38.201 V15.0.0 (2017-12), 3GPP TS 38.202 V15.1.0 (2018-03), 3GPP TS 38.211 V15.1.0 (2018-03), 3GPP TS 38.212 V15.1.1 (2018-04), 3GPP TS 38.213 V15.1.0 (2018-0312), 3GPP TS 38.214 V15.1.0 (2018-03), 3GPP TS 38.215 V15.1.0 (2018-03), 3GPP TS 38.300 V15.1.0 (2018-03), 3GPP TS 38.321 V15.1.0 (2018-03), 3GPP TS 38.322 V15.1.0 (2018-03), 3GPP TS 38.323 V15.1.0 (2018-03), 3GPP TS 38.331 V15.1.0 (2018-03), 3GPP TS 38.401 V15.1.0 (2018-03), 3GPP TS 38.410 V0.9.0 (2018-04), 3GPP TS 38.413 V0.8.0 (2018-04), 3GPP TS 38.420 V0.8.0 (2018-04), 3GPP TS 38.423 V0.8.0 (2018-04), 3GPP TS 38.470 V15.1.0 (2018-03), 3GPP TS 38.473 V15.1.1 (2018-04), 3GPP TR 38.801 V14.0.0 (2017-04), 3GPP TR 38.802 V14.2.0 (2017-09), 3GPP TR 38.803 V14.2.0 (2017-09), 3GPP TR 38.804 V14.0.0 (2017-03), 3GPP TR 38.900 V14.3.1 (2017-07), 3GPP TR 38.912 V14.1.0 (2017-06), and 3GPP TR 38.913 V14.3.0 (2017-06)

### SUMMARY

According to an aspect of the embodiments, a communication system includes: a first terminal; and a second terminal configured to: reserve a resource within a resource group that may be allocated for a data transmission, and broadcast a notification signal including reservation information on the resource, wherein the first terminal device is further configured to: receive the notification signal, select a resource to be used from the reserved resource based on the reservation information included in the notification signal, and transmit a feedback signal including radio layer information by using the selected resource to the second terminal device, and the second terminal device is further configured to: receive the feedback signal including the radio layer information from the first terminal device, allocate a resource for data transmission to the first terminal device, and release, when the feedback signal is received, reservation of the resource used for the feedback signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a radio communication system of Embodiment 1;

FIG. 2 is a block diagram illustrating an example of a mobile station of Embodiment 1;

FIG. 3A is a block diagram illustrating examples of functions of a V2V scheduler unit of a mobile station (head station);

FIG. 3B is a block diagram illustrating examples of functions of a V2V scheduler unit of a mobile station (member station);

FIG. 4 is an explanatory diagram illustrating examples of resource pools.

FIG. 5A is an explanatory diagram illustrating an example of a first orthogonal resource group;

FIG. 5B is an explanatory diagram illustrating an example of the first orthogonal resource group when orthogonal resources are selected;

FIG. 5C is an explanatory diagram illustrating an example of the first orthogonal resource group when orthogonal resources are released;

FIG. 5D is an explanatory diagram illustrating an example of the first orthogonal resource group when a member leaves;

FIG. 6 is a flowchart illustrating an example of a processing operation of a head station related to first notification signal transmission processing;

FIG. 7 is a flowchart illustrating an example of a processing operation of a member station related to first feedback processing;

FIG. 8 is a flowchart illustrating an example of a processing operation of a head station related to first resource update processing;

FIG. 9A is a block diagram illustrating examples of functions of a V2V scheduler unit of a mobile station (head station) of Embodiment 2;

FIG. 9B is a block diagram illustrating examples of functions of a V2V scheduler unit of a mobile station (member station);

FIG. 10 is a flowchart illustrating an example of a processing operation of the head station related to first notification processing;

FIG. 11 is a flowchart illustrating an example of a processing operation of the member station related to transmission processing;

FIG. 12 is a flowchart illustrating an example of a processing operation of the head station related to scheduling processing;

FIG. 13 is a flowchart illustrating an example of a processing operation of a head station related to second notification processing in Embodiment 3;

FIG. 14A is a block diagram illustrating examples of functions of a V2V scheduler unit of a mobile station (head station) of Embodiment 4;

FIG. 14B is a block diagram illustrating examples of functions of a V2V scheduler unit of a mobile station (member station);

FIG. 15A is an explanatory diagram illustrating an example of a second orthogonal resource group;

FIG. 15B is an explanatory diagram illustrating an example of the second orthogonal resource group when orthogonal subsets are selected;

FIG. 15C is an explanatory diagram illustrating an example of the second orthogonal resource group when a member leaves;

FIG. 16 is a flowchart illustrating an example of a processing operation of the head station related to second search information transmission processing;

FIG. 17 is a flowchart illustrating an example of a processing operation of the member station related to second feedback processing;

FIG. 18 is a flowchart illustrating an example of a processing operation of the head station related to second resource update processing;

FIG. 19A is a block diagram illustrating examples of functions of a V2V scheduler unit of a mobile station (member station) of Embodiment 5;

FIG. 19B is a block diagram illustrating examples of functions of a V2V scheduler unit of a mobile station (head station);

FIG. 20 is a flowchart illustrating an example of a processing operation of the member station related to subscription processing; and

FIG. 21 is a flowchart illustrating an example of a processing operation of the head station related to registration processing.

### DESCRIPTION OF EMBODIMENTS

In order for a terminal device to participate in a group of a head station so as to be a member station, a resource for discovering a head station nearby may be used. Therefore, the terminal device may use a resource for discovering a head station nearby, but the resource may become insufficient for data transmission because of the resource used for the discovery.

The disclosed technology has been made in view of above, and it is an object of the disclosed technology to attempt an improvement of usage efficiency of resources.

Hereinafter, present embodiments are described in detail with reference to the accompanying drawings. The issues and embodiments of the present specification are mere examples and not intended to limit the scope of the present disclosure. For example, when expressions described herein are different but technically equivalent, the techniques of the present disclosure may be applied even though the expressions are different, and these are not intended to limit the scope of the present disclosure. Also, the embodiments may be combined as appropriate as long as the combination does not make contradiction in the process.

Also, terms used or technical content described in the specification and contributions as standards of communication in 3GPP or the like may be appropriately used for terms used in the present specification or technical content described in the present specification. Examples of such specifications include 3GPP TS 38.211 V15.1.0 (2018-03) mentioned above.

Hereinafter, embodiments of communication systems and terminal devices disclosed in the subject application are described in detail based on drawings. Note that the following embodiments are not intended to limit the disclosed techniques.

### Embodiment 1

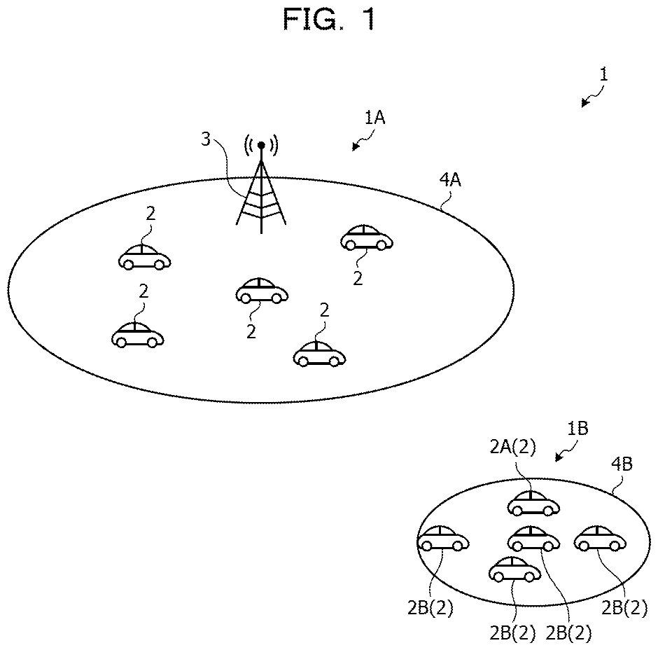

FIG. 1 is an explanatory diagram illustrating examples of radio communication systems 1 of Embodiment 1. Radio communication systems 1 illustrated in FIG. 1 include a plurality of mobile stations (user equipment: UE) 2 and a base station (BS) 3. The radio communication systems 1 support, for example, Long Term Evolution-Vehicle to Vehicle (LTE-V2V) as a resource allocation method that enables the mobile stations 2 installed in vehicles to perform direct communication between the mobile stations 2. Examples of resource allocation methods for V2V communication include mode 1 and mode 2.

In a radio communication system 1A used in mode 1, the base station 3 centrally controls resources, and thus the radio communication system 1A is applicable to the mobile stations 2 performing V2V communication in the coverage area of the base station 3. Also, in a radio communication system 1B used in mode 2, each mobile station 2 performing V2V communication performs autonomous control, and thus the radio communication system 1B is applicable to the mobile stations 2 even if the mobile stations 2 are out of coverage area in the base station 3. In the radio communication system 1B used in mode 2, for example, a plurality of mobile stations 2 driving in vehicle platooning may be grouped. Note that the vehicle platooning is a service in which, for example, a plurality of vehicles each having a mobile station 2 mounted thereon automatically travels in the form of a platoon. For example, in the group, one mobile station 2 functions as a head station 2A, and the mobile stations 2 other than the head station 2A function as member stations 2B. The head station 2A and the member stations 2B have a master-subordinate relationship. The head station 2A performs a scheduling operation that allocates resources to be used for data transmission by the other member stations 2B.

Each mobile station 2 in the radio communication system 1B used in mode 2 performs sensing on the frequency bands used for V2V communication. For example, the mobile station 2 receives sidelink control channels (SCI) on all of the frequency bands used for V2V communication in a predetermined sensing period and measures the reception electric power of corresponding sub-channels. The mobile station 2 then determines whether or not other mobile stations 2 are transmitting signals in each sub-frame and sub-channel. When detecting a transmission request for data transmission, the mobile station 2, based on the sensing results, excludes the resources that the other mobile stations 2 are likely to use and selects a vacant resource to allocate to the data transmission. Based on the sensing results, the mobile station 2 sets the resources that the other mobile stations 2 are likely to use as reserved resources in a selection window. The mobile station 2 then selects a vacant resource other than the reserved resources in the selection window and allocates the selected vacant resource to the data transmission.

Also, for mode 2, for example, a plurality of modes such as mode 2a and mode 2d are being studied. Mode 2a is a mode in which the mobile station 2 autonomously selects a sidelink resource for transmission. Also, mode 2d is a mode in which the mobile station 2 schedules sidelink transmissions of the other mobile stations 2. A group in mode 2d has a plurality of member stations 2B and a head station 2A that autonomously allocates resources to the member stations 2B, and the head station 2A allocates sidelink resources to the member stations 2B instead of the base station 3.

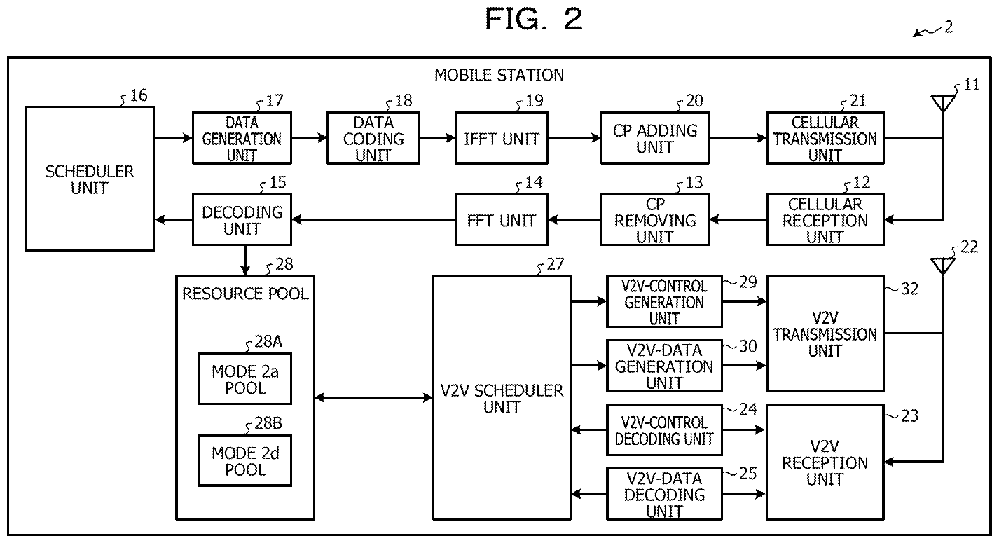

FIG. 2 is a block diagram illustrating an example of the mobile station 2 according to Embodiment 1. The mobile station 2 illustrated in FIG. 2 includes a cellular antenna 11, a cellular reception unit 12, a cyclic prefix (CP) removing unit 13, a fast Fourier transform (FFT) unit 14, a decoding unit 15, and a scheduler unit 16. The mobile station 2 further includes a data generation unit 17, a data coding unit 18, an inverse fast Fourier transform (IFFT) unit 19, a CP adding unit 20, and a cellular transmission unit 21. The mobile station 2 further includes a V2V antenna 22, a V2V reception unit 23, a V2V-control decoding unit 24, a V2V-data decoding unit 25, a V2V scheduler unit 27, and a resource pool 28. The mobile station 2 includes a V2V-control generation unit 29, a V2V-data generation unit 30, and a V2V transmission unit 32.

The cellular antenna 11 transmits and receives radio signals over a radio carrier used, for example, by the radio communication system 1A in mode 1. The cellular reception unit 12 receives radio signals through the cellular antenna 11 and executes radio reception processes such as down conversion and A/D conversion on the received signals, for example. The CP removing unit 13 removes CPs added in units of symbols to received signals. The CP removing unit 13 then outputs the received signals subjected to CP removal to the FFT unit 14. The FFT unit 14 performs a fast Fourier transform on the received signals outputted from the CP removing unit 13 to convert the received signals in the time slot into received signals in the frequency domain. The received signals include data, control signals, and the like transmitted from the base station 3. The decoding unit 15 demodulates and decodes the received signals in the frequency domain after the conversion by the FFT unit 14 to obtain the data in the received signals. The decoding unit 15 demodulates and decodes the received signals in the frequency domain after the conversion to obtain control signals.

The scheduler unit 16 executes scheduling to allocate radio resources to the data to transmit or receive to or from the base station 3. For example, the scheduler unit 16 executes uplink scheduling from the mobile stations 2 to the base station 3 to allocate radio resources to data to be transmitted by the mobile stations 2. The scheduler unit 16 executes downlink scheduling from the base station 3 to the mobile stations 2.

The data generation unit 17 generates data to transmit to the base station 3. The data coding unit 18 codes and modulates the generated data and outputs the modulated data to the IFFT unit 19. The IFFT unit 19 performs an inverse fast Fourier transform on the data outputted from the data generation unit 17 to convert the transmission signals in the frequency domain into transmission signals in the time slot. The IFFT unit 19 then outputs the transmission signals in the time slot to the CP adding unit 20. The CP adding unit 20 adds CPs in units of symbols to the transmission signals outputted from the IFFT unit 19. The CP adding unit 20 then outputs the transmission signals having the added CPs to the cellular transmission unit 21. The cellular transmission unit 21 executes radio transmission processes such as D/A conversion and up conversion on the transmission signals and then transmits the radio signals through the cellular antenna 11.

Also, the V2V antenna 22 transmits and receives radio signals for V2V communication, for example, used for the radio communication system 1B in mode 2. The V2V reception unit 23 receives radio signals through the V2V antenna 22 and executes radio reception processes such as down conversion and A/D conversion on the received signals, for example. The V2V-control decoding unit 24 decodes the received signals subjected to the reception processes at the V2V reception unit 23 to obtain V2V control signals included in the received signals. The V2V control signals are control information in the sub-channels in the PSSCH in the received signals. The V2V-data decoding unit 25 decodes the received signals subjected to the reception processes at the V2V reception unit 23 to obtain V2V data signals included in the received signals. The V2V data signals are data in the sub-channels in the PSSCH in the received signals.

The V2V scheduler unit 27 executes scheduling to allocate resources used for V2V communication to data to transmit or receive to or from a V2V mobile station 2. The resource pool 28 manages resources to be used for V2V communication, such as a mode 2a pool 28A and a mode 2d pool 28B, which will be described below. The V2V-control generation unit 29 generates V2V control signals to transmit to a mobile station 2 as a transmission destination, for example, control information for the sub-channels. The V2V-data generation unit 30 generates V2V data signals to transmit to a mobile station 2 as a transmission destination, for example, data for the sub-channels. The V2V transmission unit 32 executes radio transmission processes such as D/A conversion and up conversion on V2V transmission signals including the V2V control signals generated at the V2V-control generation unit 29 and the V2V data signals generated at the V2V-data generation unit 30. The V2V transmission unit 32 then transmits the V2V radio signals subjected to the radio transmission processes through the V2V antenna

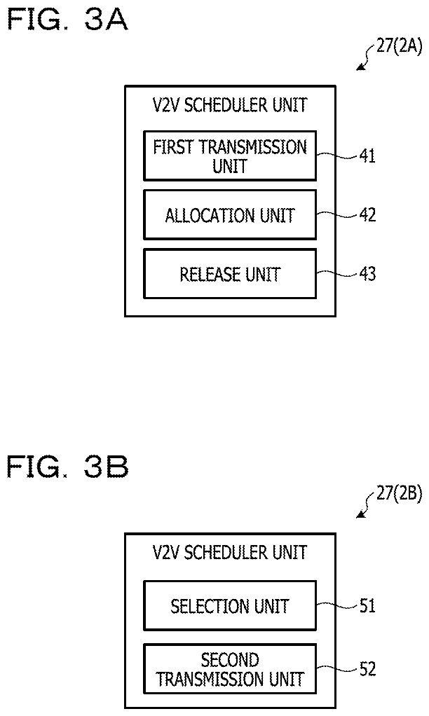

FIG. 3A is a block diagram illustrating examples of functions of the V2V scheduler unit 27 in the mobile station 2 (head station 2A), and FIG. 3B is a block diagram illustrating examples of functions of the V2V scheduler unit 27 in the mobile station 2 (member station 2B). The V2V scheduler unit 27 in the head station 2A illustrated in FIG. 3A reads a program stored in a read-only memory (ROM), not illustrated, and executes the read program to implement functions of, for example, a first transmission unit 41, an allocation unit 42, and a release unit 43. The first transmission unit 41 broadcasts a notification signal including a first orthogonal resource group 100 including orthogonal resources from a part of the mode 2d pool 28B that may be allocated to data transmission. Note that the orthogonal resource is a resource in an orthogonal state for returning a feedback signal to request participation in a group. The feedback signal is a returned signal for requesting group participation to the head station 2A. When receiving a feedback signal (returned signal) from the member station 2B, the allocation unit 42, based on radio layer information within the feedback signal, allocates a resource for data transmission to the member station 2B relating to the radio layer information. After recognizing QoS information within the radio layer information, the allocation unit 42 allocates a resource for data transmission by, for example, examining two different synchronous or asynchronous traffic types. Furthermore, when receiving a feedback signal, the release unit 43 releases a reservation for the orthogonal resource used for the feedback signal and returns the orthogonal resource to the mode 2d pool 28B for the data transmission.

Also, the V2V scheduler unit 27 in the member station 2B illustrated in FIG. 3B reads a program stored in a ROM, not illustrated, and executes the read program to implement functions of, for example, a selection unit 51 and a second transmission unit 52. When receiving a notification signal, the selection unit 51 selects an orthogonal resource within the first orthogonal resource group 100 within the notification signal. The selection unit 51 designates one orthogonal resource from the first orthogonal resource group 100 and executes a short-term sensing process on the designated orthogonal resource. Note that, when an orthogonal resource is being used based on the sensing result, the short-term sensing process executes a sensing process by designating the next candidate orthogonal resource that is not designated, instead of sensing all orthogonal resources. Furthermore, when the orthogonal resource is vacant based on the sensing result, the selection unit 51 selects the vacant orthogonal resource. The second transmission unit 52 reserves the selected orthogonal resource and transmits a feedback signal including radio layer information of the member station 2B to the head station 2A.

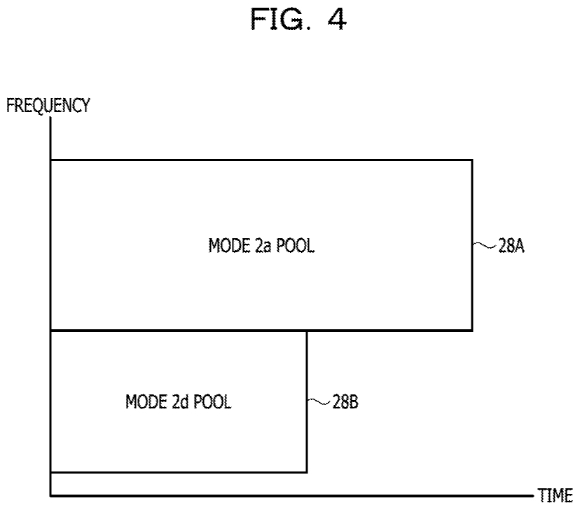

FIG. 4 is an explanatory diagram illustrating examples of the resource pools 28 in Embodiment 1. The resource pools 28 include a mode 2a pool 28A that manages resources in mode 2a and a mode 2d pool 28B that manages resources in mode 2d. The mode 2a pool 28A is a resource pool to be autonomously allocated by the station. The mode 2d pool 28B is a resource pool to be allocated to the member station 2B by the head station 2A.

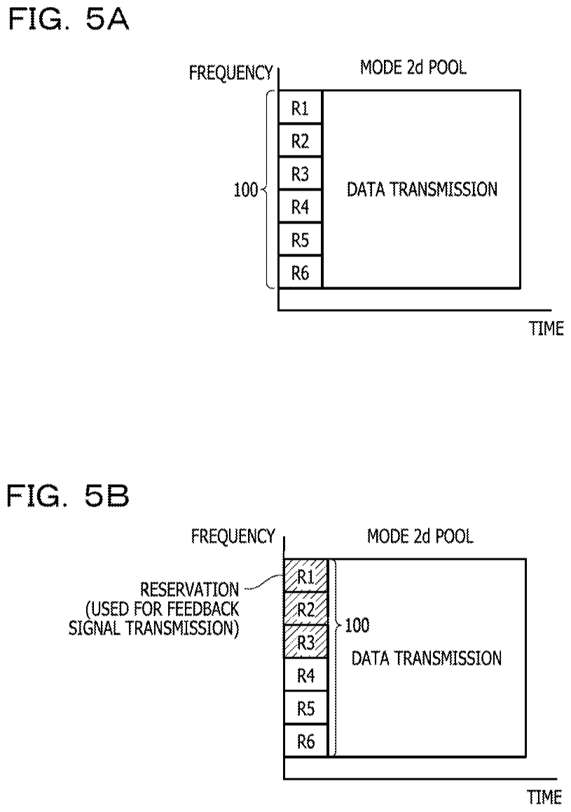

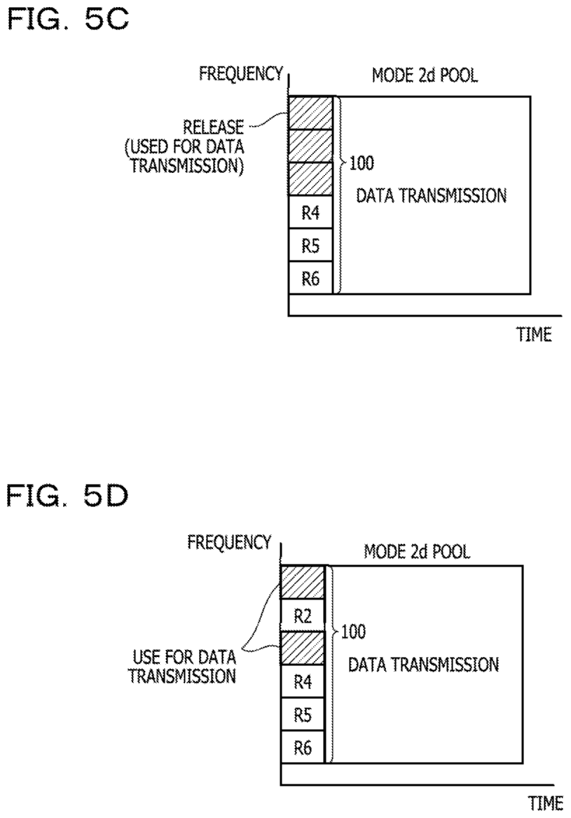

FIG. 5A is an explanatory diagram illustrating an example of the first orthogonal resource group 100. The head station 2A generates a first orthogonal resource group 100 including partial orthogonal resources R1 to R6 of the mode 2d pool 28B. Note that, for convenience of description, it is assumed that the first orthogonal resource group 100 includes six orthogonal resources R1 to R6 and that the orthogonal resources R1 to R6 have a vacant state in which reservation may be performed. Each of the orthogonal resources is a resource to be used for transmission of a feedback signal in response to a notification signal. Note that, for convenience of description, the first orthogonal resource group 100 stores, for example, six orthogonal resources R1 to R6. The head station 2A broadcasts by SCI a notification signal including the first orthogonal resource group 100 by using the mode 2a pool 28A. As a result, the mobile station 2 which requests to participate in the group of the head station 2A as the member station 2B receives the notification signal from the head station 2A and obtains the first orthogonal resource group 100 within the received notification signal.

FIG. 5B is an explanatory diagram illustrating an example of the first orthogonal resource group 100 when orthogonal resources are selected. The mobile station 2 designates one orthogonal resource within the first orthogonal resource group 100, executes a short-term sensing process on the designated orthogonal resource, and determines whether or not the orthogonal resource is vacant. When the orthogonal resource is vacant, the mobile station 2 selects the vacant orthogonal resource. Also, when the orthogonal resource is not vacant, the mobile station 2 designates an orthogonal resource that is not designated within the first orthogonal resource group 100 and executes a short-term sensing process on the designated orthogonal resource. When the orthogonal resource is vacant based on the sensing result, the mobile station 2 selects (reserves) the vacant orthogonal resource and then transmits a feedback signal in response to the notification signal to the head station 2A by using the vacant orthogonal resource. Note that, in the first orthogonal resource group 100 illustrated in FIG. 5B, the orthogonal resources R1 to R3 are reserved, and the orthogonal resources R4 to R6 are available for reservation for feedback signal transmission.

FIG. 5C is an explanatory diagram illustrating an example of the first orthogonal resource group 100 when orthogonal resources are released. When receiving a feedback signal from the mobile station 2 by using the orthogonal resources, the head station 2A registers the mobile station 2 as a member station 2B. Furthermore, the head station 2A releases a reservation of the orthogonal resource used for receiving the feedback signal and returns the orthogonal resource to the mode 2d pool 28B for the data transmission. For example, when receiving a feedback signal by using the three orthogonal resources R1 to R3 within the plurality of orthogonal resources R1 to R6, the head station 2A releases the orthogonal resources R1 to R3 and returns them to the mode 2d pool 28B. Therefore, in the first orthogonal resource group 100 illustrated in FIG. 5C, the orthogonal resources R1 to R3 are returned to the mode 2d pool 28B for data transmission, and the orthogonal resources R4 to R6 are available for reservation for feedback signal transmission.

FIG. 5D is an explanatory diagram illustrating an example of the first orthogonal resource group 100 when a member leaves. In order for the member station 2B to request to leave the group of the head station 2A, the member station 2B transmits a leave request signal to the head station 2A. When receiving the leave request signal from the member station 2B, the head station 2A returns the orthogonal resource R2 used for the feedback signal by the member station 2B to the first orthogonal resource group 100. As a result, in the first orthogonal resource group 100 illustrated in FIG. 5D, the orthogonal resources R2 and R4 to R6 are available for reservation for feedback signal transmission.

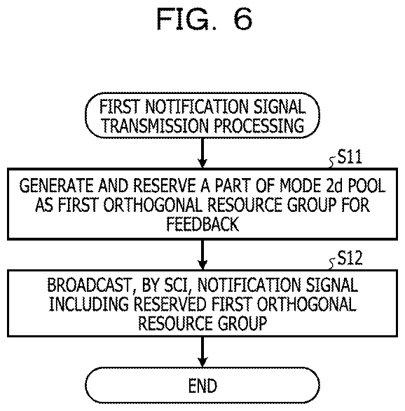

FIG. 6 is a flowchart illustrating an example of a processing operation of the head station 2A related to first notification signal transmission processing. Referring to FIG. 6, the first transmission unit 41 in the head station 2A generates a part of the mode 2d pool 28B as the first orthogonal resource group 100 and temporarily reserves the first orthogonal resource group 100 for feedback signal transmission (step S11). The first transmission unit 41 broadcasts a notification signal including the reserved first orthogonal resource group 100 by using SCI of the mode 2a pool 28A (step S12) and ends the processing operation illustrated in FIG. 6.

The head station 2A uses a part of the mode 2d pool 28B as the first orthogonal resource group 100 of the orthogonal resources and broadcasts a notification signal including the first orthogonal resource group 100. As a result, the head station 2A may transmit an orthogonal resource for feedback signal transmission for member participation to neighboring mobile stations 2. Furthermore, the mobile station 2 requesting to be the member station 2B may recognize the orthogonal resource for feedback signal transmission.

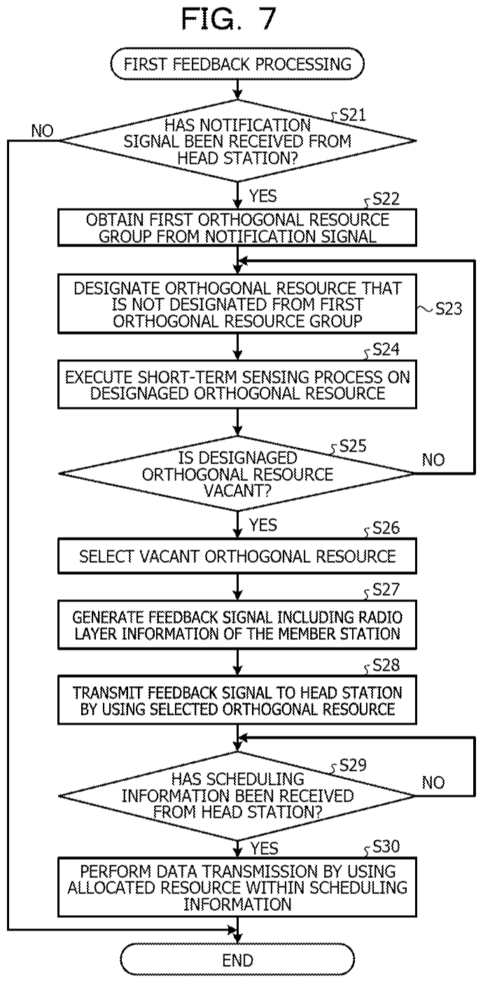

FIG. 7 is a flowchart illustrating an example of a processing operation of the member station 2B related to first feedback processing. Note that, although a processing operation which executes first feedback processing as the member station 2B will be described for convenience of description, the mobile station 2 requesting group participation becomes the member station 2B of the head station 2A after executing the first feedback processing. Referring to FIG. 7, the selection unit 51 in the member station 2B determines whether or not a notification signal has been received from the head station 2A by using the mode 2a pool 28A (step S21). When a notification signal has been received (positive in step S21), the selection unit 51 obtains the first orthogonal resource group 100 from the notification signal (step S22).

The selection unit 51 designates, after obtaining the first orthogonal resource group 100, an orthogonal resource that is not designated from the obtained first orthogonal resource group 100 (step S23). After designating an orthogonal resource that is not designated, the selection unit 51 executes a short-term sensing process on the designated orthogonal resource (step S24). The selection unit 51 determines whether or not the designated orthogonal resource is vacant based on the sensing result (step S25).

When the designated orthogonal resource is vacant (positive in step S25), the selection unit 51 selects the vacant orthogonal resource (step S26). Furthermore, after the vacant orthogonal resource is selected, the second transmission unit 52 in the member station 2B generates radio layer information of the member station 2B and generates a feedback signal including the radio layer information (step S27). Note that the radio layer information is, for example, mobile station performance information, layer 2 identification information (ID), buffer state information (currently used data size), QoS information (such as synchronous or asynchronous communication) or the like. The second transmission unit 52 transmits the feedback signal to the head station 2A by using the mode 2d pool 28B and by using the selected orthogonal resource (step S28).

Furthermore, the member station 2B determines whether or not scheduling information has been received from the head station 2A (step S29). When scheduling information has been received (positive in step S29), the member station 2B performs data transmission by using the allocated resource within the scheduling information (step S30) and ends the processing operation illustrated in FIG. 7.

Also, when a notification signal has not been received from the head station 2A (negative in step S21), the member station 2B ends the processing operation illustrated in FIG. 7. Also, when the designated orthogonal resource is not vacant (negative in step S25), the member station 2B moves to step S23 so as to designate an orthogonal resource that is not designated. Also, when the scheduling information has not been received from the head station 2A (negative in step S29), the member station 2B moves to the processing operation in step S29 so as to determine whether or not scheduling information is received.

When a notification signal has been received from the head station 2A, a mobile station 2 obtains the first orthogonal resource group 100 from the notification signal, designates an orthogonal resource within the first orthogonal resource group 100, and executes a short-term sensing process on the designated orthogonal resource. When the designated orthogonal resource is vacant based on the sensing result, the mobile station 2 transmits a feedback signal including radio layer information of the mobile station 2 to the head station 2A by using the vacant orthogonal resource. As a result, because the mobile station 2 transmits the feedback signal to the head station 2A by using the orthogonal resource within the first orthogonal resource group 100, the mobile station 2 may participate in the group as the member station 2B.

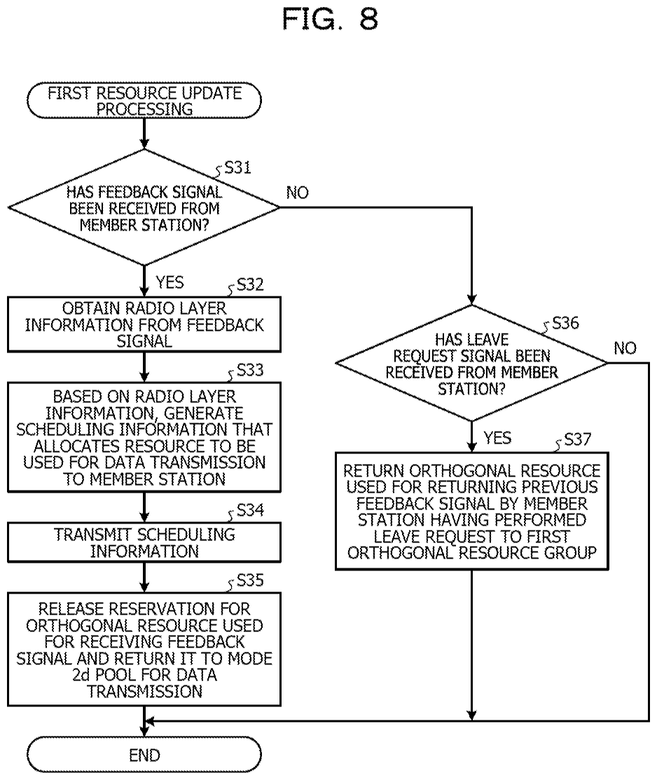

FIG. 8 is a flowchart illustrating an example of a processing operation of the head station 2A related to first resource update processing. Referring to FIG. 8, the head station 2A determines whether or not a feedback signal has been received from the member station 2B (step S31). When a feedback signal has been received (positive in step S31), the head station 2A obtains radio layer information from the feedback signal (step S32).

After obtaining the radio layer information, the head station 2A identifies the mobile station 2 (member station 2B) having transmitted the feedback signal based on the radio layer information. Furthermore, the head station 2A generates scheduling information that allocates a resource to be used for data transmission by the member station 2B of the radio layer information (step S33). The head station 2A transmits the generated scheduling information to the member station 2B (step S34). After receiving the feedback signal, the release unit 43 in the head station 2A releases a reservation for the orthogonal resource used for reception of the feedback signal and returns the released orthogonal resource to the mode 2d pool 28B for data transmission (step S35). The head station 2A then ends the processing operation illustrated in FIG. 8.

When the feedback signal has not been received (negative in step S31), the head station 2A determines whether or not a leave request signal has been received from the member station 2B (step S36). When the leave request signal has been received (positive in step S36), the head station 2A returns the orthogonal resource used for reception of the previous feedback signal by the member station 2B having performed the leave request to the first orthogonal resource group 100 (step S37) and ends the processing operation illustrated in FIG. 8. When the leave request signal has not been received from the member station 2B (negative in step S36), the head station 2A ends the processing operation illustrated in FIG. 8.

When receiving the feedback signal by using the orthogonal resource, the head station 2A returns the orthogonal resource for the feedback signal transmission to the mode 2d pool for data transmission. As a result, an improvement of the usage efficiency of resources may be attempted.

When receiving the leave request signal from the member station 2B, the head station 2A returns the orthogonal resource used for reception of the feedback signal by the member station 2B having performed the leave request to the first orthogonal resource group 100. As a result, by returning the orthogonal resource to the first orthogonal resource, an improvement of the usage efficiency of the orthogonal resource for feedback signal transmission may be attempted.

According to Embodiment 1, because a resource is temporally reserved and is dynamically updated for sidelink discovery, the usage efficiency of resources may be increased.

Note that, having exemplarily described that the first orthogonal resource group 100 of Embodiment 1 has six orthogonal resources in a case where, for example, the number of stations that may participate in the group is six, the number of orthogonal resources is not limited to six but may be changed as appropriate in accordance with the number of stations that may participate in the group. Note that the six orthogonal resources are represented by 3 bits and may be represented by using 3 bits within the SCI format.

Also, in order to increase the number of stations that participate in the group, the head station 2A may increase the number of resources within the first orthogonal resource group 100 at the next time. Also, in order to reduce the number of stations that participate in the group, the head station 2A may reduce the number of resources within the first orthogonal resource group 100 at the next time, which may be changed as appropriate.

Having exemplarily described the case where the first orthogonal resource group 100 includes a plurality of resources according to Embodiment 1 above, the first orthogonal resource group 100 may include a plurality of subsets of a plurality of resources, which may be changed as appropriate. Note that, having described the example in which the first orthogonal resource group is provided according to Embodiment 1 above, a group/subset of resources that are not orthogonal may be provided.

### Embodiment 2

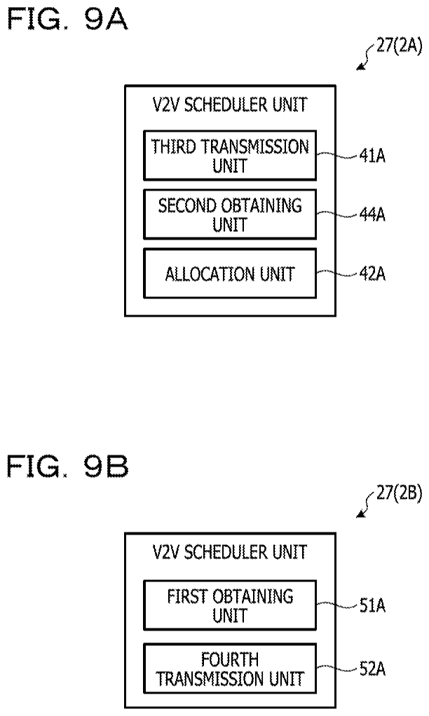

Next, a radio communication system 1B according to Embodiment 2 will be described when a head station 2A having obtained resource pool information from a base station 3 operates out of the coverage in the base station. FIG. 9A is a block diagram illustrating examples of functions of a V2V scheduler unit 27 in a mobile station 2 (head station 2A), and FIG. 9B is a block diagram illustrating examples of functions of a V2V scheduler unit 27 in a mobile station 2 (member station 2B). The V2V scheduler unit 27 in the head station 2A illustrated in FIG. 9A reads a program stored in a ROM, not illustrated, and executes the read program to implement functions of, for example, a third transmission unit 41A, a second obtaining unit 44A, and an allocation unit 42A. The third transmission unit 41A broadcasts a notification signal including resource pool information for identifying a resource group that is permitted by the base station 3 and that may be allocated. When receiving a scheduling request signal from the member station 2B, the second obtaining unit 44A obtains radio layer information from the scheduling request signal. The allocation unit 42A allocates a resource for data transmission to the member station 2B with reference to the obtained radio layer information.

Also, the V2V scheduler unit 27 in the member station 2B illustrated in FIG. 9B reads a program stored in a ROM, not illustrated, and executes the read program to implement functions of, for example, a first obtaining unit 51A and a fourth transmission unit 52A. When receiving a notification signal from the head station 2A, the first obtaining unit 51A obtains resource pool information within the notification signal. Based on the obtained resource pool information, the fourth transmission unit 52A transmits a scheduling request signal including the radio layer information of the member station 2B to the head station 2A.

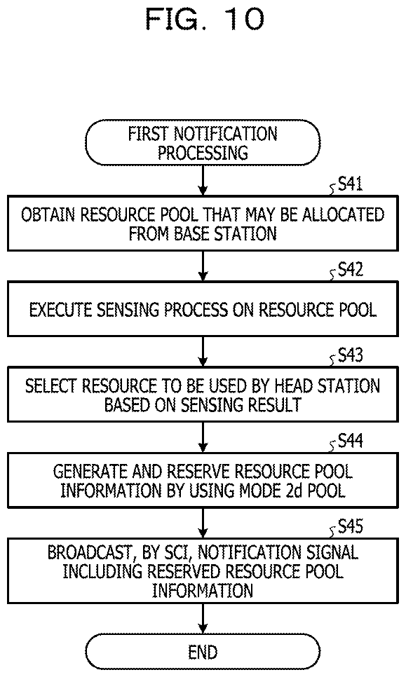

FIG. 10 is a flowchart illustrating an example of a processing operation of the head station 2A related to first notification processing. Referring to FIG. 10, the head station 2A obtains a resource pool that may be allocated from the base station 3 (step S41). After obtaining the resource pool that may be allocated from the base station 3, the head station 2A executes a sensing process on the resource pool (step S42). After executing the sensing process on the resource pool, the head station 2A selects a resource (or a plurality of resources/a plurality of subsets) to be used by the head station 2A based on the sensing result (step S43).

The head station 2A out of the coverage of the base station 3 generates and reserves the resource pool information by using the mode 2d pool 28B (step S44), broadcasts by SCI a notification signal including the resource pool information (step S45), and ends the processing operation illustrated in FIG. 10.

The head station 2A generates resource pool information by using the mode 2d pool 28B and broadcasts a notification signal including the resource pool information. As a result, when receiving the notification signal, the member station 2B may recognize the resource pool information that may be allocated.

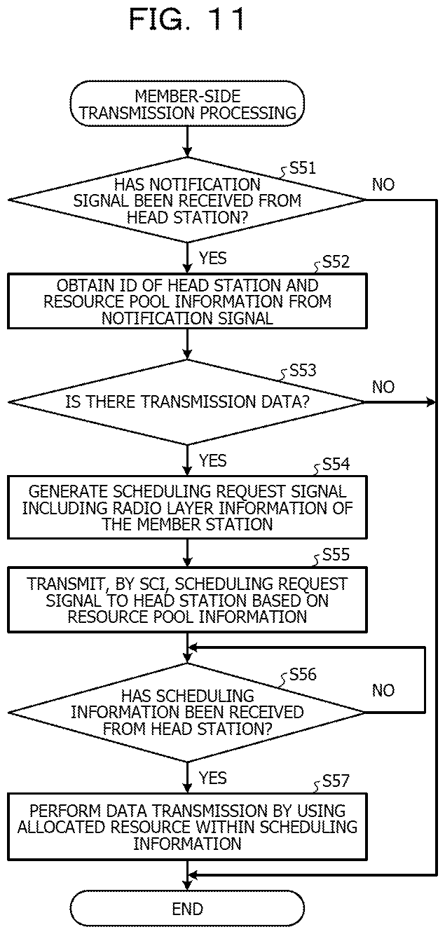

FIG. 11 is a flowchart illustrating an example of a processing operation of the member station 2B related to transmission processing. Referring to FIG. 11, the first obtaining unit 51A within the member station 2B determines whether or not a notification signal has been received from the head station 2A (step S51). When a notification signal has been received from the head station 2A (positive in step S51), the first obtaining unit 51A obtains an ID of the head station 2A and the resource pool information from the notification signal (step S52). As a result, the member station 2B may recognize the head station 2A that manages the resource pool information.

The fourth transmission unit 52A within the member station 2B determines whether or not there is transmission data(step S53). When there is transmission data (positive in step S53), the fourth transmission unit 52A generates a scheduling request signal including radio layer information of the member station 2B (step S54).

After generating the scheduling request signal, based on the resource pool information, the fourth transmission unit 52A transmits by SCI the scheduling request signal to the head station 2A (step S55). After transmitting the scheduling request signal, the member station 2B determines whether or not scheduling information has been received from the head station 2A (step S56). When scheduling information has been received (positive in step S56), the member station 2B performs data transmission by using an allocated resource within the scheduling information (step S57) and ends the processing operation illustrated in FIG. 11.

When a notification signal has not been received from the head station 2A (negative in step S51), the member station 2B ends the processing operation illustrated in FIG. 11. When there is not transmission data (negative in step S53), the member station 2B ends the processing operation illustrated in FIG. 11. Also, when the scheduling information has not been received from the head station 2A (negative in step S56), the member station 2B moves to step S56 so as to determine whether or not scheduling information has been received or not.

When there is transmission data, the member station 2B transmits a scheduling request signal to the head station 2A. As a result, the head station 2A may allocate a resource to the member station 2B having issued the scheduling request signal via SCI.

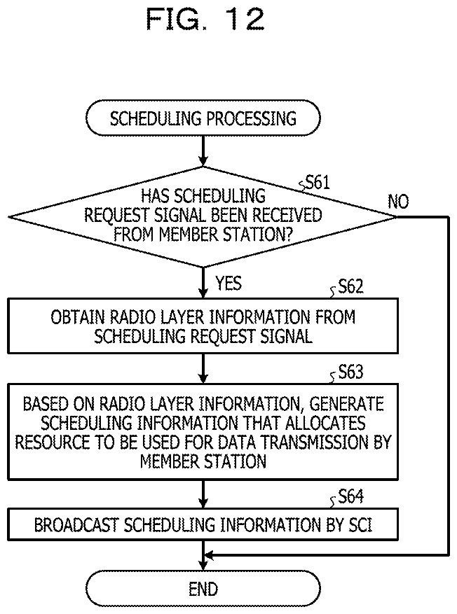

FIG. 12 is a flowchart illustrating an example of a processing operation of the head station 2A related to scheduling processing. Referring to FIG. 12, the second obtaining unit 44A within the head station 2A out of the coverage of the base station 3 determines whether or not a scheduling request signal has been received from the member station 2B (step S61). When receiving a scheduling request signal from the member station 2B (positive in step S61), the second obtaining unit 44A obtains radio layer information from the scheduling request signal (step S62).

After obtaining the radio layer information, the allocation unit 42A within the head station 2A generates scheduling information that allocates a resource to be used for data transmission to the member station 2B of the radio layer information (step S63). The allocation unit 42A transmits the generated scheduling information to the member station 2B (step S64) and ends the processing operation illustrated in FIG. 8.

When receiving the scheduling request signal from the member station 2B, the head station 2A obtains the radio layer information within the scheduling request signal and transmits the scheduling information on the resource to be used for data transmission to the member station 2B of the radio layer information. As a result, the member station 2B may realize the data transmission based on the resource information within the scheduling information from the head station 2A.

For example, when unicast communication is to be executed between member stations 2B from the transmission side member station 2B to the reception side member station 2B, it is assumed that initial transmission, retransmission and ACK/NACK feedback are executed. Accordingly, the head station 2A selects a resource to be used for the initial transmission, reserves a resource to be used for the retransmission, and selects a resource to be used for the ACK/NACK feedback from the reception side member station 2B. In this case, the ID of the layer 2 is used for ACK/NACK of a Hybrid Automatic Retransmission Request (HARQ). After that, the transmission side member station 2B may decrypt the HARQ. For example, the head station 2A broadcasts by SCI the scheduling information that allocates each resource for the initial transmission, retransmission and ACK/NACK feedback to the transmission side member station 2B and the reception side member station 2B.

Note that the case has been exemplarily described in which, based on the resource pool information permitted by the base station 3, the head station 2A in Embodiment 2 above allocates vacant resources to be used for data transmission to the member stations 2B. However, when receiving a notification signal from the head station 2A, each of the member stations 2B may execute a sensing process on the resources within the resource pool based on the resource pool information within the notification signal. In this case, based on the sensing result, each of the member stations 2B may select an unused vacant resource to be used for ACK/NACK feedback or data transmission, which may be changed as appropriate.

For example, a radio system is assumed which includes a member station 2B and a head station 2A that allocates a resource to be used for data transmission to the member station 2B. The head station 2A performs sensing for each resource or subset within a resource group that is managed by the base station and that may be allocated. Furthermore, based on the sensing result, the head station 2A selects one resource or subset. Furthermore, by using the selected resource or subset, the head station 2A broadcasts a notification signal including resource pool information for identifying each resource within the resource group that may be allocated for data transmission. When receiving the notification signal, the member station 2B obtains the resource pool information within the notification signal. Based on the obtained resource pool information, the member station 2B allocates a resource for data transmission. In this case, the member station 2B may not transmit a scheduling request for the resource allocation to the head station 2A.

Also, having exemplarily described a resource to be allocated for data transmission according to Embodiment 2, an embodiment is not limited to the resource, but a subset may be applied, which may be changed as appropriate.

### Embodiment 3

Next, a radio communication system 1B of Embodiment 3 will be described when a head station 2A having obtained resource pool information from a base station 3 operates inside the coverage in the base station 3. Note that the same configurations as in Embodiment 2 are denoted by the same reference numerals, and repetitive description of such configurations and operations is omitted.

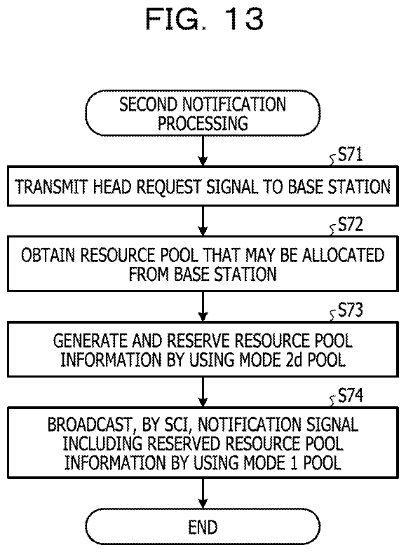

FIG. 13 is a flowchart illustrating an example of a processing operation of a head station 2A related to second notification processing in Embodiment 3. Referring to FIG. 13, the head station 2A transmits a head request signal to the base station 3 (step S71). After transmitting the head request signal, the head station 2A obtains a subset that may be allocated from the base station 3 (step S72). The head station 2A generates resource pool information by using the mode 2d pool 28B and reserves the resource pool information (step S73).

The head station 2A inside the coverage of the base station 3 broadcasts by SCI a notification signal including the reserved resource pool information by using a mode 1 pool, not illustrated, (step S74) and ends the processing operation illustrated in FIG. 13. Note that the mode 1 pool is a resource pool to be used by the base station 3 for allocating a resource to each mobile station 2.

The head station 2A inside the coverage of the base station 3 generates resource pool information by using the mode 2d pool 28B and broadcasts a notification signal including the reserved resource pool information by using the mode 1 pool. As a result, also within the coverage of the base station 3, the head station 2A distributes the resource pool information that may be allocated to each of the member stations 2B. Furthermore, each of the member stations 2B may recognize the resource pool information that may be allocated.

Note that, having exemplarily described the case in which the head station 2A in Embodiment 3 obtains resource pool information from the base station 3 in accordance with the head request signal when the head station 2A is inside the coverage of the base station 3, the base station 3 may notify the head station 2A of the resource pool information via an upper layer, which may be changed as appropriate.

The case has been exemplarily described in which, based on the resource pool information permitted by the base station 3, the head station 2A in Embodiment 3 above allocates vacant resources to be used for data transmission to the member stations 2B. However, when receiving a notification signal from the head station 2A, each of the member stations 2B may execute a sensing process on the resources within the resource pool based on the resource pool information within the notification signal. In this case, based on the sensing result, each of the member stations 2B may select an unused vacant resource to be used for ACK/NACK feedback or data transmission, which may be changed as appropriate.

Also, having exemplarily described a resource to be allocated for data transmission according to Embodiment 3, an embodiment is not limited to the resource, but a subset may be applied, which may be changed as appropriate.

### Embodiment 4

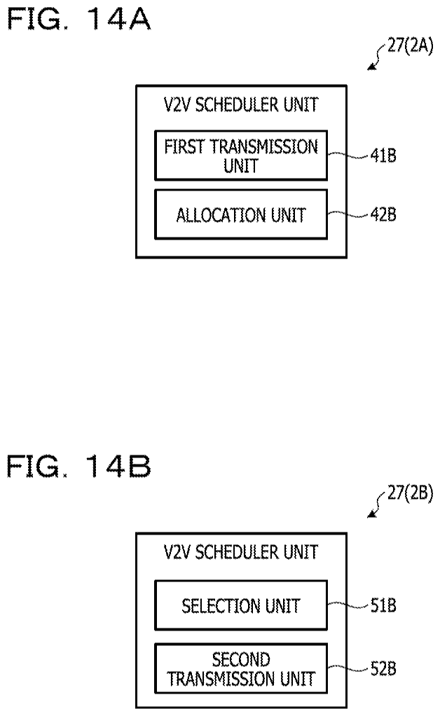

Next, a radio communication system 1B of Embodiment 4 will be described. To the head station 2A, the base station 3 designates one mobile station 2 within a plurality of mobile stations 2 by using an upper layer. FIG. 14A is a block diagram illustrating examples of functions of a V2V scheduler unit 27 in a mobile station 2 (head station 2A), and FIG. 14B is a block diagram illustrating examples of functions of a V2V scheduler unit 27 in a mobile station 2 (member station 2B). The V2V scheduler unit 27 in the head station 2A illustrated in FIG. 14A reads a program stored in a ROM, not illustrated, and executes the read program to implement functions of, for example, a first transmission unit 41B and an allocation unit 42B. The first transmission unit 41B divides the entire mode 2d pool 28B that may be allocated for data transmission into a plurality of orthogonal subsets and broadcasts a notification signal including a second orthogonal resource group 110 including the plurality of orthogonal subsets. When receiving a feedback signal from the member station 2B, the allocation unit 42B, based on radio layer information within the feedback signal, allocates a resource for data transmission to the member station 2B relating to the radio layer information.

Also, the V2V scheduler unit 27 in the member station 2B illustrated in FIG. 14B reads a program stored in a ROM, not illustrated, and executes the read program to implement functions of, for example, a selection unit 51B and a second transmission unit 52B. When receiving a notification signal, the selection unit 51B selects an orthogonal subset within the second orthogonal resource group 110 within the notification signal. Note that the orthogonal subset is a resource group to be used for feedback signal transmission and for data transmission. The selection unit 51B designates one orthogonal subset from the second orthogonal resource group 110 and executes a short-term sensing process on the designated orthogonal subset. Furthermore, when the orthogonal subset is vacant, the selection unit 51B selects the vacant orthogonal subset. The second transmission unit 52B reserves the selected orthogonal subset and transmits a feedback signal including radio layer information of the member station 2B to the head station 2A.

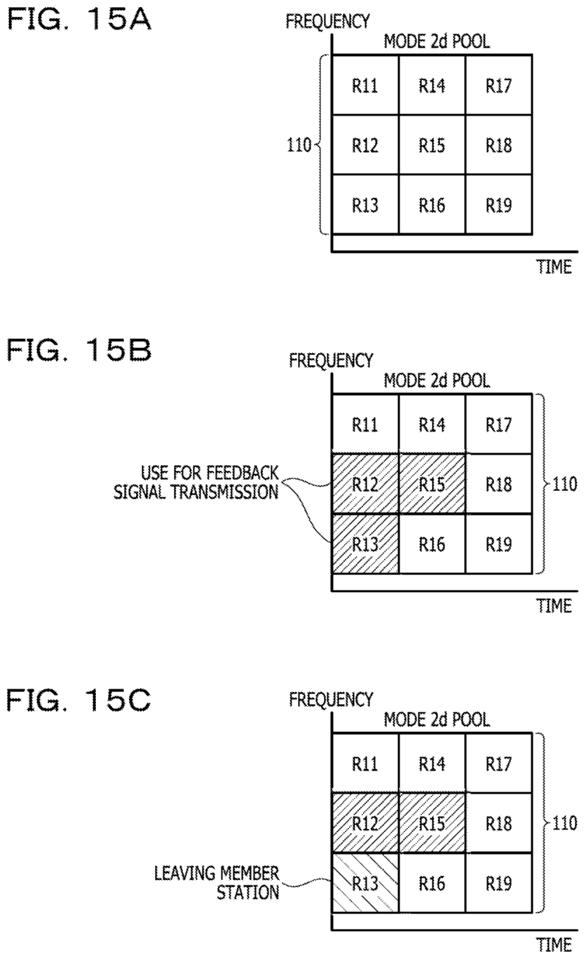

FIG. 15A is an explanatory diagram illustrating an example of the second orthogonal resource group 110. The head station 2A divides the entire mode 2d pool 28B into a predetermined number of orthogonal subsets and generates the second orthogonal resource group 110 including the predetermined number of orthogonal subsets. Note that, for convenience of description, the second orthogonal resource group 110 illustrated in FIG. 15A has, for example, a total of nine orthogonal subsets R11 to R19. The second orthogonal resource group 110 is a resource group to be used for transmission of a feedback signal in response to a notification signal. The head station 2A broadcasts a notification signal including the second orthogonal resource group 110. As a result, the mobile station 2 which requests to participate in a group of the head station 2A as the member station 2B receives the notification signal and obtains the second orthogonal resource group 110 within the received notification signal.

FIG. 15B is an explanatory diagram illustrating an example of the second orthogonal resource group 110 when orthogonal subsets are selected. The mobile station 2 designates one orthogonal subset within the second orthogonal resource group 110 and executes a short-term sensing process on the designated orthogonal subset. The mobile station 2 determines whether or not the orthogonal subset is vacant. When the orthogonal subset is vacant, the mobile station 2 selects the vacant orthogonal subset. Also, when the orthogonal subset is not vacant, the mobile station 2 designates an orthogonal subset that is not designated within the second orthogonal resource group 110 and executes a short-term sensing process on the designated orthogonal subset. After selecting the vacant orthogonal subset, the mobile station 2 transmits to the head station 2A a feedback signal including radio layer information of the mobile station 2 to the notification signal by using the vacant orthogonal subset. The second orthogonal resource group 110 illustrated in FIG. 15B uses, for example, orthogonal subsets R12, R13 and R15 as being reserved for feedback signal transmission and handles the remaining orthogonal subsets as being available for reservation.

FIG. 15C is an explanatory diagram illustrating an example of the second orthogonal resource group 110 when a member leaves. In order for the member station 2B to request to leave the group of the head station 2A, the member station 2B transmits a leave request signal to the head station 2A. When receiving the leave request signal from the member station 2B, the head station 2A returns the orthogonal resource used for a feedback signal by the member station 2B to the second orthogonal resource group 110. When the member station 2B having used the orthogonal subset R13 for data transmission leaves the group, the second orthogonal resource group 110 illustrated in FIG. 15C releases the orthogonal subset R13.

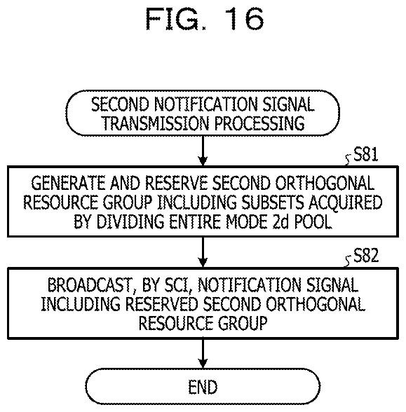

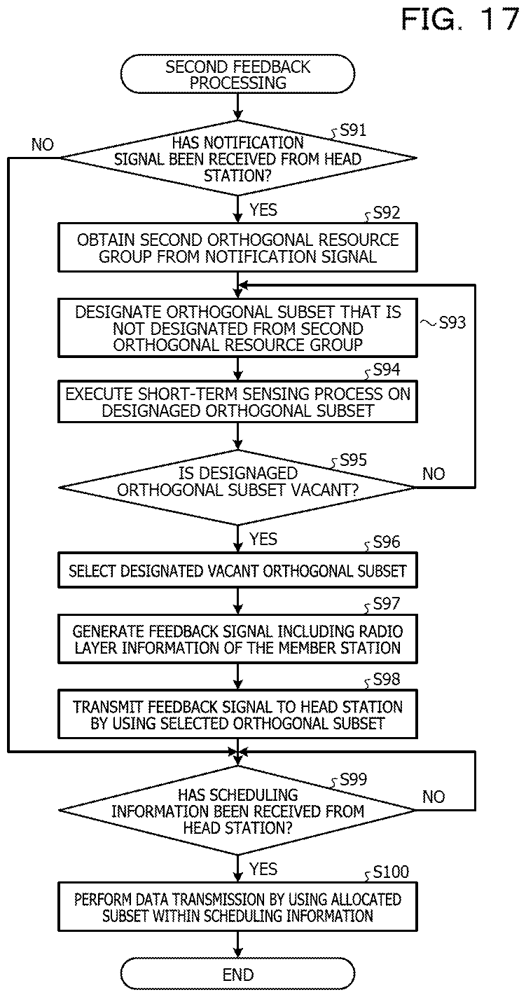

FIG. 16 is a flowchart illustrating an example of a processing operation of the head station 2A related to second notification signal transmission processing. Referring to FIG. 16, the first transmission unit 41B in the head station 2A divides the entire mode 2d pool 28B into a predetermined number of orthogonal subsets. Furthermore, the first transmission unit 41B generates the second orthogonal resource group 110 including the plurality of divided orthogonal subsets and reserves the second orthogonal resource group 110 (step S81). The first transmission unit 41B broadcasts by SCI a notification signal including the reserved second orthogonal resource group 110 (step S82) and ends the processing operation illustrated in FIG. 16.

The head station 2A divides the entire mode 2d pool 28B into a predetermined number of orthogonal subsets, generates the second orthogonal resource group 110 including the plurality of orthogonal subsets, and broadcasts a notification signal including the second orthogonal resource group 110. As a result, each of the mobile stations 2 requesting to participate in the group of the head station 2A may recognize the orthogonal subset to be used for feedback signal transmission and for data transmission with reference to the second orthogonal resource group 110 within the notification signal.

FIG. 17 is a flowchart illustrating an example of a processing operation of the member station 2B related to second feedback processing. Referring to FIG. 17, the selection unit 51B within the member station 2B determines whether or not a notification signal has been received from the head station 2A (step S91). When a notification signal has been received (positive in step S91), the selection unit 51B obtains the second orthogonal resource group 110 from the notification signal (step S92).

The selection unit 51B after obtaining the second orthogonal resource group 110 designates an orthogonal subset that is not designated from the obtained second orthogonal resource group 110 (step S93). After designating an orthogonal subset that is not designated, the selection unit 51B executes a short-term sensing process on the designated orthogonal subset (step S94). The selection unit 51B determines whether or not the orthogonal subset is vacant based on the sensing result (step S95).

When the orthogonal subset is vacant (positive in step S95), the selection unit 51B selects the vacant orthogonal subset (step S96). Furthermore, after the vacant orthogonal subset is selected, the second transmission unit 52B in the member station 2B generates radio layer information of the member station 2B and generates a feedback signal including the radio layer information (step S97). The second transmission unit 52B transmits the feedback signal to the head station 2A by using the selected orthogonal subset (step S98).

Furthermore, the member station 2B determines whether or not scheduling information has been received from the head station 2A (step S99). When scheduling information has been received (positive in step S99), the member station 2B performs data transmission by using an allocated subset within the scheduling information (step S100) and ends the processing operation illustrated in FIG. 17.

Also, when a notification signal has not been received from the head station 2A (negative in step S91), the member station 2B ends the processing operation illustrated in FIG. 17. Also, when the designated orthogonal subset is not vacant (negative in step S95), the member station 2B moves to step S93 so as to designate an orthogonal subset that is not designated. Also, when scheduling information has not been received from the head station 2A (negative in step S99), the member station 2B moves to the processing operation in step S99 so as to determine whether or not scheduling information is received.

When a notification signal has been received from the head station 2A, the mobile station 2 obtains the second orthogonal resource group 110 from the notification signal, designates an orthogonal subset within the second orthogonal resource group 110 and executes a short-term sensing process on the designated orthogonal subset. When the designated orthogonal subset is vacant based on the sensing result, the mobile station 2 transmits a feedback signal including radio layer information of the mobile station 2 to the head station 2A by using the vacant orthogonal subset. As a result, because the mobile station 2 transmits the feedback signal to the head station 2A by using the orthogonal subset within the second orthogonal resource group 110, the mobile station 2 may participate in the group as the member station 2B.

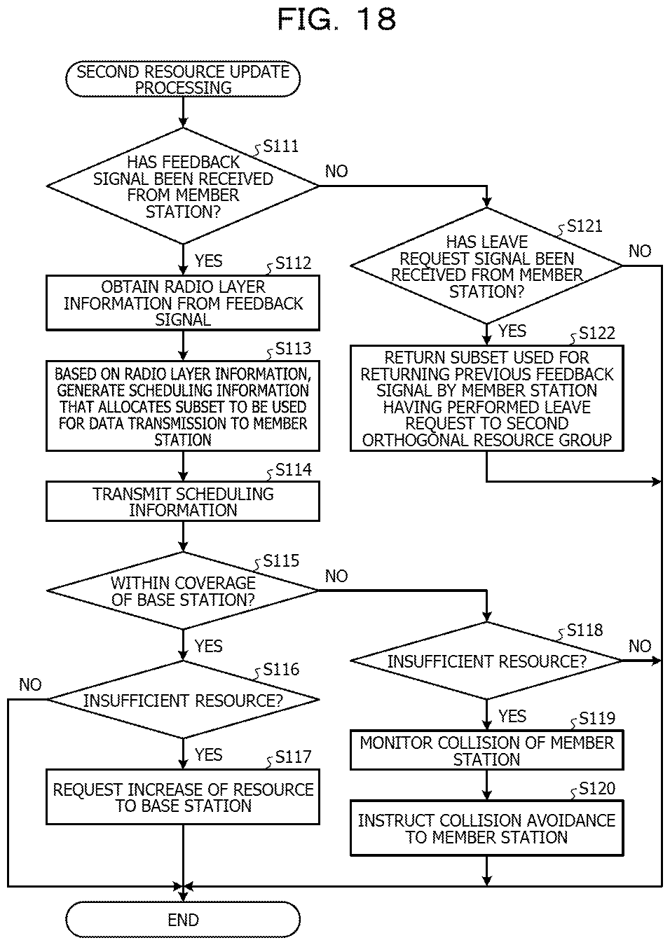

FIG. 18 is a flowchart illustrating an example of a processing operation of the head station 2A related to second resource update processing. Referring to FIG. 18, the allocation unit 42B within the head station 2A determines whether or not a feedback signal has been received from the member station 2B (step S111). When a feedback signal has been received (positive in step S111), the allocation unit 42B obtains radio layer information from the feedback signal (step S112).

After obtaining the radio layer information, the allocation unit 42B generates scheduling information that allocates an orthogonal subset to be used for data transmission to the member station 2B of the radio layer information based on the radio layer information (step S113). Note that the orthogonal subset to be used for data transmission by the member station 2B may be the same subset used for feedback signal transmission or may be changed as appropriate. The allocation unit 42B transmits the generated scheduling information to the member station 2B (step S114).

After transmitting the scheduling information to the member station 2B, the head station 2A determines whether or not the head station 2A is inside the coverage of the base station 3 (step S115). When the head station 2A is inside the coverage of the base station 3 (positive in step S115), the head station 2A determines whether or not the resource is insufficient (step S116). When the resource is insufficient (positive in S116), the head station 2A within the coverage of the base station 3 requests an increase of the resource of the second orthogonal resource group 110 to the base station 3 (step S117) and ends the processing operation illustrated in FIG. 18. As a result, the base station 3 increases the amount of resource of the mode 2d pool 28B and dynamically increases the second orthogonal resource group 110.

When the head station 2A is not inside the coverage of the base station 3, for example, when it is out of the coverage (negative in step S115), the head station 2A determines whether or not the resource is insufficient (step S118). When the resource is insufficient (positive in step S118), the head station 2A monitors a collision of the member stations 2B via SCI (step S119). Based on the monitoring result, the head station 2A out of the coverage of the base station 3 instructs collision avoidance to the member stations 2B due to the insufficient resource of the mode 2d pool 28B (step S120) and ends the processing operation illustrated in FIG. 18. For example, in order to avoid a collision, the head station 2A out of the coverage of the base station 3 instructs partial member stations 2B to use the mode 2a pool 28A.

When the feedback signal has not been received (negative in step S111), the head station 2A determines whether or not a leave request signal has been received from the member station 2B (step S121). When a leave request signal has been received (positive in step S121), the head station 2A returns the orthogonal subset used for reception of the previous feedback signal by the member station 2B having performed the leave request to the second orthogonal resource group 110 (step S122) and ends the processing operation illustrated in FIG. 18.

When the leave request signal has not been received from the member station 2B (negative in step S121), the head station 2A ends the processing operation illustrated in FIG. 18. When the resource is not insufficient (negative in step S116), the head station 2A ends the processing operation illustrated in FIG. 18. Also, when the resource is not insufficient (negative in step S118), the head station 2A ends the processing operation illustrated in FIG. 18.

When the feedback signal is received by using the orthogonal subset, the head station 2A uses the orthogonal subset used for the feedback signal transmission to the member station 2B also for the data transmission. As a result, the member station 2B may attempt an improvement of the usage efficiency of resources.

When receiving a leave request signal from the member station 2B, the head station 2A returns the orthogonal subset used for reception of the feedback signal by the member station 2B having performed the leave request to the second orthogonal resource group 110. As a result, an improvement of usage efficiency of the orthogonal subset for feedback signal transmission may be attempted.

Also, when the resource is insufficient, the head station 2A inside the coverage of the base station 3 requests the base station 3 to increase the resource. As a result, because the base station 3 increases the resource of the mode 2d pool 28B and increases the resource of the second orthogonal resource group 110, an improvement of the usage efficiency of the resources of the second orthogonal resource group 110 may be attempted.

Also, when the resource is insufficient, the head station 2A inside the coverage of the base station 3 instructs collision avoidance to the member stations 2B. As a result, in accordance with the collision avoidance instruction, each of the member stations 2B uses the mode 2a pool 28A, and an improvement of the usage efficiency of the resources of the second orthogonal resource group 110 is attempted.

Note that the case has been exemplarily described in which, after receiving the feedback signal, the head station 2A of Embodiment 4 uses the orthogonal subset used for reception of the feedback signal for the data transmission. However, the head station 2A may release reservation of the orthogonal subset and return the released orthogonal subset to the mode 2d pool 28B for data transmission, which may be changed as appropriate.

### Embodiment 5

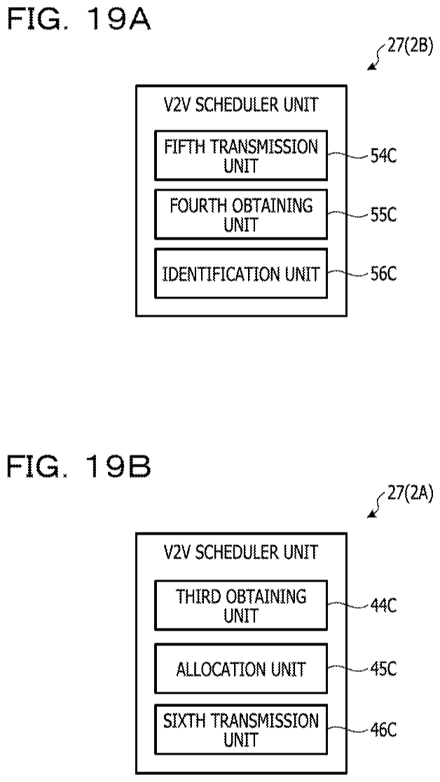

Next, a radio communication system 1B of Embodiment 5 will be described. Note that the same configurations as in Embodiment 1 are denoted by the same reference numerals, and repetitive description of such configurations and operations is omitted. FIG. 19A is a block diagram illustrating examples of functions of a V2V scheduler unit 27 in a mobile station (member station 2B), and FIG. 19B is a block diagram illustrating examples of functions of a V2V scheduler unit 27 in a mobile station 2 (head station 2A). The V2V scheduler unit 27 in the member station 2B illustrated in FIG. 19A reads a program stored in a ROM, not illustrated, and executes the read program to implement functions of, for example, a fifth transmission unit 54C, a fourth obtaining unit 55C and an identification unit 56C. The fifth transmission unit 54C broadcasts a discovery signal including radio layer information of the member station 2B. When receiving a scheduling signal from the head station 2A, the fourth obtaining unit 55C obtains allocation table information within the scheduling signal. The allocation table information is information that manages reserved resources in association with each of the member stations 2B. The identification unit 56C identifies a resource to be used for data transmission by the member station 2B with reference to the obtained allocation table information.

Also, the V2V scheduler unit 27 in the head station 2A illustrated in FIG. 19B reads a program stored in a ROM, not illustrated, and executes the read program to implement functions of, for example, a third obtaining unit 44C, an allocation unit 45C, and a sixth transmission unit 46C. When receiving the discovery signal from the mobile station 2, the third obtaining unit 44C obtains radio layer information from the discovery signal. The allocation unit 45C generates allocation table information that associates reserved resources with each of the member stations 2B with reference to the obtained radio layer information (such as a layer 2 ID). The sixth transmission unit 46C transmits a scheduling signal including the allocation table information to the member stations 2B.

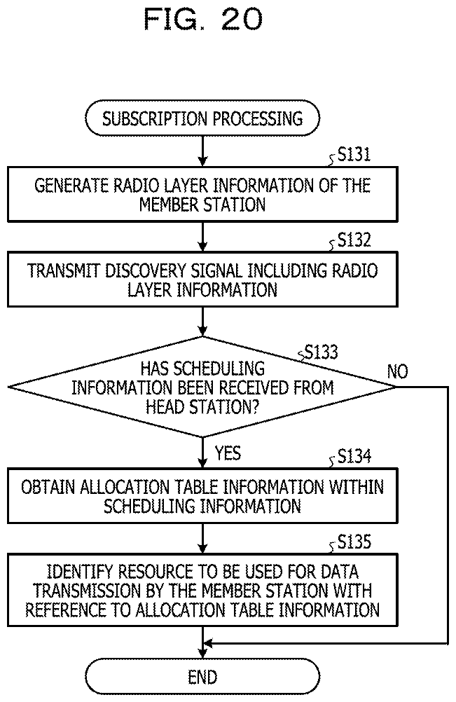

FIG. 20 is a flowchart illustrating an example of a processing operation of a member station 2B related to subscription processing. Referring to FIG. 20, the fifth transmission unit 54C in the member station 2B generates radio layer information on the member station 2B (step S131). The fifth transmission unit 54C broadcasts a discovery signal including the radio layer information to the head station 2A (step S132).

The fourth obtaining unit 55C in the member station 2B determines whether or not scheduling information has been received from the head station 2A (step S133). When receiving the scheduling information (positive in step S133), the fourth obtaining unit 55C obtains the allocation table information within the scheduling information (step S134).

After obtaining the allocation table information within the scheduling information, the identification unit 56C in the member station 2B identifies a resource to be used for data transmission by the member station 2B with reference to the allocation table information (step S135) and ends the processing operation illustrated in FIG. 20. When scheduling information has not been received from the head station 2A (negative in step S133), the member station 2B ends the processing operation illustrated in FIG.

The member station 2B broadcasts a discovery signal including radio layer information of the member station 2B to the head station 2A. As a result, the head station 2A may recognize the mobile station 2 that requests group participation from the discovery signal.

Furthermore, when receiving the scheduling information including the allocation table information, the member station 2B identifies the resource to be used for data transmission by the member station 2B with reference to the allocation table information. As a result, the member station 2B may recognize the resource to be used for data transmission.

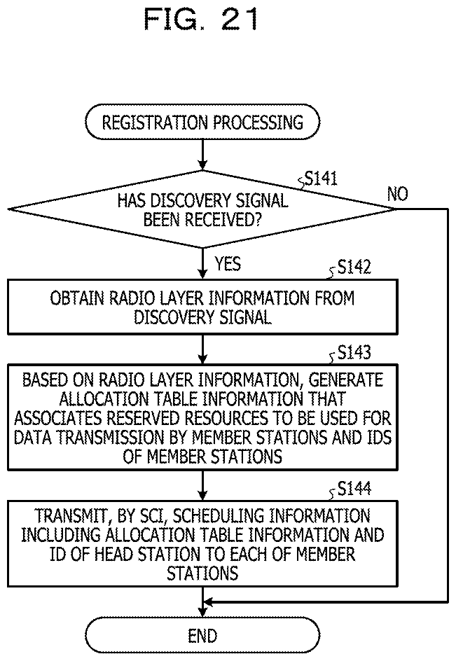

FIG. 21 is a flowchart illustrating an example of a processing operation of the head station 2A related to registration processing. Referring to FIG. 21, the third obtaining unit 44C in the head station 2A determines whether or not a discovery signal has been received from another mobile station 2 (step S141). When receiving a discovery signal (positive in step S141), the third obtaining unit 44C obtains radio layer information from the discovery signal (step S142).

After obtaining the radio layer information, the allocation unit 45C in the head station 2A generates allocation table information that associates reserved resources to be used for data transmission by the member stations 2B and IDs of the member stations 2B based on the radio layer information (step S143). After generating the allocation table information, the sixth transmission unit 46C in the head station 2A transmits by SCI the scheduling information including the allocation table information and the ID of the head station 2A to each of the member stations 2B (step S144) and ends the processing operation illustrated in FIG. 21. When the discovery signal has not been received (negative in step S141), the head station 2A ends the processing operation illustrated in FIG. 21.

When receiving the discovery signal from the member station 2B, the head station 2A generates allocation table information that manages reserved resources for the member stations 2B based on the radio layer information within the discovery signal. Furthermore, the head station 2A transmits to each of the member stations 2B the scheduling information including the allocation table information and the ID of the head station 2A. As a result, each of the member stations 2B may identify the resource to be used for data transmission by the member station 2B with reference to the allocation table information within the scheduling information.

Note that the head station 2A of Embodiment 4 may set a part of resources for each of the member stations 2B by using an upper layer message such as a radio resource control (RRC) message, which may be changed as appropriate. In this case, after receiving the discovery signal from each of the member stations 2B, the head station 2A may recognize the ID of the layer 2 of each of the member stations 2B. After that, the head station 2A may use RRC that allocates a resource to the member station 2B based on the ID of the layer 2.

Although the above embodiments are based on examples of the radio communication system 1B for V2V communication, the present disclosure is applicable, for example, to V2X communication such as V2P communication and V2I communication.

### REFERENCE SIGNS LIST

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication system comprising:
a first terminal; and
a second terminal configured to:
reserve a resource within a resource group that may be allocated for a data transmission, and
broadcast a notification signal including reservation information on the resource, wherein
the first terminal device is further configured to:
receive the notification signal,
select a resource to be used from the reserved resource based on the reservation information included in the notification signal, and
transmit a feedback signal including radio layer information by using the selected resource to the second terminal device, and
the second terminal device is further configured to:
receive the feedback signal including the radio layer information from the first terminal device,
allocate a resource for data transmission to the first terminal device, and
release, when the feedback signal is received, reservation of the resource used for the feedback signal.

2. The communication system according to claim 1, wherein the first terminal device is further configured to:
designate one subset resource from the resource group,
perform sensing on the designated subset resource, and
select a vacant resource.

3. The communication system according to claim 1, wherein the first terminal device is further configured to:
designate a plurality of subset resources from the resource group,
perform sensing on the plurality of designated subset resources, and
select one vacant subset resource.

4. The communication system according to claim 1, wherein the second terminal device is further configured to:
reserve a resource by using partial resources of the resource group, and
broadcast the notification signal including reservation information on the resource.

5. The communication system according to claim 1, wherein the second terminal device is further configured to:
reserve a plurality of resources acquired by dividing the entire resource group, and
broadcast the notification signal including reservation information on the resources.

6. A terminal device that allocates a resource to be used for data transmission to another terminal device, the terminal device comprising:
a transmitter configured to broadcast a notification signal including reservation information on a resource within a resource group that may be allocated for the data transmission;
a receiver configured to receive, when the other terminal device having received the notification signal uses a resource selected from the reservation information within the notification signal, a feedback signal including radio layer information of the other terminal device from the other terminal device, and
a controller configured to:
allocate a resource for data transmission to the first terminal device, and
release reservation of the resource used for the feedback signal.

7. A terminal device that executes data transmission by using a resource allocated to another terminal device, the terminal device comprising:
a receiver configured to receive, from the other terminal device, a notification signal including resource reservation information that a resource within a resource group that may be allocated for the data transmission; and
a transmitter configured to transmit a feedback signal including radio layer information to the other terminal device by using a resource which is selected from the resource within the resource group based on the resource reservation information included in the notification signal.

8. A communication system comprising:
a first terminal device; and
a second terminal device configured to:
broadcast a notification signal including resource pool information for identifying resources within a resource group that may be allocated for a data transmission, wherein
the first terminal device is further configured to:
obtain the resource pool information within the notification signal when receiving the notification signal, and
transmit, based on the obtained resource pool information, a scheduling request signal including the radio layer information of the first terminal device to the second terminal device, and
the second terminal device is further configured to:
obtain, when receiving the scheduling request signal, the radio layer information from the scheduling request signal, and
allocate the resource for data transmission to the first terminal device having transmitted the scheduling request signal with reference to the obtained radio layer information.

9. A communication system comprising:
a first terminal device; and
a second terminal device configured to:
perform sensing for resources or subsets within a resource group that is managed by a base station and may be allocated,
select one resource or subset based on a sensing result, and
broadcasts, by using the selected resource or subset, a notification signal including resource pool information identifying resources within the resource group that may be allocated for data transmission, wherein
the first terminal device is configured to:
obtain, when receiving the notification signal, the resource pool information within the notification signal, and
allocate the resource for data transmission based on the obtained resource pool information.

10. A communication system comprising:
a first terminal device configured to transmit a discovery signal including radio layer information of the first terminal device; and
a second terminal device configured to:
obtain, when receiving the discovery signal, the radio layer information from the discovery signal,
generate table information that manages resources reserved for the first terminal device related to the radio layer information with reference to the obtained radio layer information, and
transmit a scheduling signal including the table information to the first terminal device, wherein
the first terminal device is further configured to:
obtain, when receiving the scheduling signal, table information within the scheduling signal, and
identify a resource for data transmission by the first terminal device with reference to the obtained table information.
